(19) United States
(12) Patent Application Publication
(10) Pub. No.: US 2018/0307744 A1
(43) Pub. Date: Oct. 25, 2018

(54) NAMED ENTITY-BASED CATEGORY TAGGING OF DOCUMENTS

(71) Applicant: Microsoft Technology Licensing, LLC, Redmond, WA (US)

(72) Inventors: Vyankatesh Ramesh Gadekar, Hyderabad (IN); Pramod Nammi, Andhra Pradesh (IN); Kaustav Mukherjee, Hyderabad (IN)

(21) Appl. No.: 15/497,164

(22) Filed: Apr. 25, 2017

(51) Int. Cl. G06F 17/30; G06F 17/27; G06K 9/00

(52) U.S. Cl. CPC G06F 17/30601; G06F 17/2785; G06F 17/30604; G06F 17/278; G06K 9/00442

(57) ABSTRACT

A facility for attributing subject categories to documents in a set of documents collected on behalf of the user is described. For each document in the set of documents, based on semantic analysis of the document, the facility identifies one or more direct subjects for the document. The facility attributes to the document the direct subjects identified for the document. Based on semantic analysis across the documents of the set, the facility identifies one or more collective subjects each for a proper subset of the set of documents. The facility attributes each identified collective subject to each document of the subset of the set of documents for which it was identified.

### BACKGROUND

Electronic documents can contain content such as text, spreadsheets, slides, diagrams, charts, and images.

Browsers are applications that display documents, such as web pages. Some conventional browsers allow users to collect a set of documents, such as by manually bookmarking them; manually adding them to a document reading list; or automatically adding them to a history list as the user accesses them. Typically, a user can review such a collected set of documents to be reminded of his or her history of interacting with them, and select individual documents from the set to read.

### SUMMARY

This summary is provided to introduce a selection of concepts in a simplified form that are further described below in the Detailed Description. This summary is not intended to identify key factors or essential features of the claimed subject matter, nor is it intended to be used to limit the scope of the claimed subject matter.

A facility for attributing subject categories to documents in a set of documents collected on behalf of the user is described. For each document in the set of documents, based on semantic analysis of the document, the facility identifies one or more direct subjects for the document. The facility attributes to the document the direct subjects identified for the document. Based on semantic analysis across the documents of the set, the facility identifies one or more collective subjects each for a proper subset of the set of documents. The facility attributes each identified collective subject to each document of the subset of the set of documents for which it was identified.

### BRIEF DESCRIPTION OF THE DRAWINGS

FIG. 1 is a network diagram showing the environment in which the facility operates in some examples.

FIG. 2 is a block diagram showing some of the components typically incorporated in at least some of the computer systems and other devices on which the facility operates.

FIG. 3 is a flow diagram showing a process performed by the facility to determine direct categories in some examples.

FIG. 4 is a graph diagram showing a sample entity relationship graph for the named entity “George Lucas” retrieved or constructed by the facility in some examples.

FIG. 5 is a graph diagram showing a sample entity relationship graph for the named entity “Harrison Ford” retrieved or constructed by the facility in some examples.

FIGS. 6-8 are graph diagrams showing additional graphs obtained and processed by the facility in order to select direct categories for six additional documents in the example.

FIG. 9 is a data structure diagram showing sample contents of a document category table used by the facility in some examples to store categories attributed to documents for use by a particular user.

FIG. 10 is a data structure diagram showing sample contents of a path table used by the facility in some examples to store all of the root-to-leaf paths among the entity relationship graphs obtained for each document in the document set.

FIG. 11 is a flow diagram showing a first process performed by the facility in some examples to identify collective categories for a set of documents.

FIG. 12 is a graph diagram showing a sample master graph constructed by the facility based upon the example discussed above in connection with FIGS. 4-8.

FIG. 13 is a graph diagram showing sample contents of a master graph updated to reflect the selection of collective categories.

FIG. 14 is a data structure diagram showing sample contents of the path table updated to reflect the selection of collective categories.

FIG. 15 is a data structure diagram showing sample contents of the document category table updated to reflect the addition of collective categories.

FIG. 16 is a flow diagram showing a second process performed by the facility in some examples to select a new collective category for a set of documents.

FIG. 17 is a flow diagram showing a third process performed by the facility in some examples to select new collective categories for a set of documents.

FIG. 18 is a data structure diagram showing sample contents of a parent weight table used by the facility in some examples to store the pattern of connection between entities among the entity relationship graphs obtained for named entities occurring in documents or set of documents.

FIG. 19 is a flow diagram showing a process perform by the facility in some examples to make categories attributed to documents available to the user.

FIG. 20 is a display diagram showing an entire reading list user interface presented by the facility in some examples.

FIG. 21 is a display diagram showing the entire reading list user interface after it has been updated to include collective categories.

FIG. 22 is a display diagram showing the reading list user interface updated to display the documents in a single category.

FIG. 23 is a display diagram showing a category hierarchy user interface presented by the facility in some examples.

### DETAILED DESCRIPTION

The inventors have identified important disadvantages in how browsers conventionally manage a collected set of documents. In particular, the only common form of organization for collected set of documents is sorting them by date, such as by the date on which each was bookmarked by the user, added to a reading list for the user, or accessed by the user.

The inventors have recognized that, as collected sets of documents grow to each include tens, hundreds, or even thousands of documents, it becomes increasingly difficult for a user to find in a set particular documents that he or she seeks. For example, were a user to have a reading list containing 80 documents, four of which relate to fantasy films, finding these may involve extensive, repeated scrolling of the entire list, periodically clicking through listed documents to assess whether they relate to fantasy films. Even in cases where a reading list is searchable, a query for “fantasy films” may produce many false negatives (documents that are directed to that subject but did not literally contain that phrase, and thus are not included in the query result), or even false positives (documents that are not directed to that subject, but to contain that phrase, and thus are included in the query result).

In response to this recognition, the inventors have conceived and reduced to practice a software and/or hardware facility for tagging documents with relevant categories using named-entity analysis (“the facility”). In particular, for each document in a set of documents, the facility identifies one or more category tags characterizing the subject of the document. In various examples, the facility exposes these category tags for documents in various ways, allowing readers to select documents for reading, for example, based on their category tags. For example, in various examples, the facility: displays a list of documents and, with each listed document, its category tags; when a user types a query matching a category tag, displays a list of the documents having that category tag; when a user clicks on a category tag associated with a particular document, displays a list of the documents having that category tag; displays a hierarchy of categories that have been tagged to documents, and allows a user to click on one, thereafter displaying a list of the documents having that category tag; etc.

In some examples, for each document to be tagged, the facility determines a “direct category” with which to tag the document corresponding to the document's most likely subject. Further, the facility identifies “collective categories” with which to tag documents that relate to groups of documents within the set. For example, the facility may tag a first group of documents relating to the movie The Princess Bride with a “The Princess Bride” direct category, and tag a second group of documents relating to the movie Star Wars with a “Star Wars” direct category. The facility may further tag all of the documents in the first and second groups with a “film (fantasy)” collective category to which all of these documents are likely to relate.

In some examples, the facility uses named entities to attribute direct categories and collective categories to documents. In particular, in some examples, to use named entities to attribute direct categories to documents, the facility identifies named entities referenced in the document, and analyzes entity relationship graphs each specifying relationships between one of these referenced named entities and other named entities related to the referenced named entity. The named entities whose references the facility identifies in the document are ways of referring to real-world objects, such as the names of people, organizations, or locations; the names of substances or biological species; other “rigid designators;” expressions of times, quantities, monetary values, or percentages; etc. For each named entity reference in the document, the facility retrieves or constructs an entity relationship graph: a data structure specifying direct and indirect relationships between the referenced named entity and other, more general named entities related to the referenced one. In each entity relationship graph, the reference named entity is described as the “root” of the graph. The facility compares the entity relationship graphs for the named entities referenced by a document, and selects as the direct category of the document an entity that occurs in all or most of these entity relationship graphs, at a relatively short average distance from their roots. (As the distance of entities from the root increases, the entities grow increasingly more general and less specific, and typically less strongly related to the reference entity of the graph's root.)

In some examples, to use named entities to attribute collective categories to documents in a set, the facility collects the entity relationship graphs that apply to the documents of the set, and analyzes them to identify additional entities that occur frequently in the collected graphs. In various examples, this involves: (a) directly analyzing a “master graph” compiled from the entity relationship graphs for each document in the set; (b) analyzing root-to-leaf paths into which these entity relationship graphs are decomposed; or (c) analyzing connectivity statistics compiled from the entity relationship graphs and/or the master graph.

By performing in some or all of these ways, the facility makes it easy for a user to identify and read documents relating to a particular subject. In this way, the facility relieves the user of a burden conventionally imposed on the user to identify and read documents relating to a particular subject, allowing them to read documents that are, in many cases, more relevant to their interest, and in less time, than they could using conventional techniques.

Also, by performing in some or all of the ways described above and storing, organizing, and accessing information relating to document categorization in efficient ways, the facility meaningfully reduces the hardware resources needed to store and exploit this information, including, for example: reducing the amount of storage space needed to store the information relating to document categorization; and reducing the number of processing cycles needed to store, retrieve, or process the information relating to document categorization. This allows programs making use of the facility to execute on computer systems that have less storage and processing capacity, occupy less physical space, consume less energy, produce less heat, and are less expensive to acquire and operate. Also, such a computer system can respond to user requests pertaining to information relating to document categorization with less latency, producing a better user experience and allowing users to do a particular amount of work in less time.

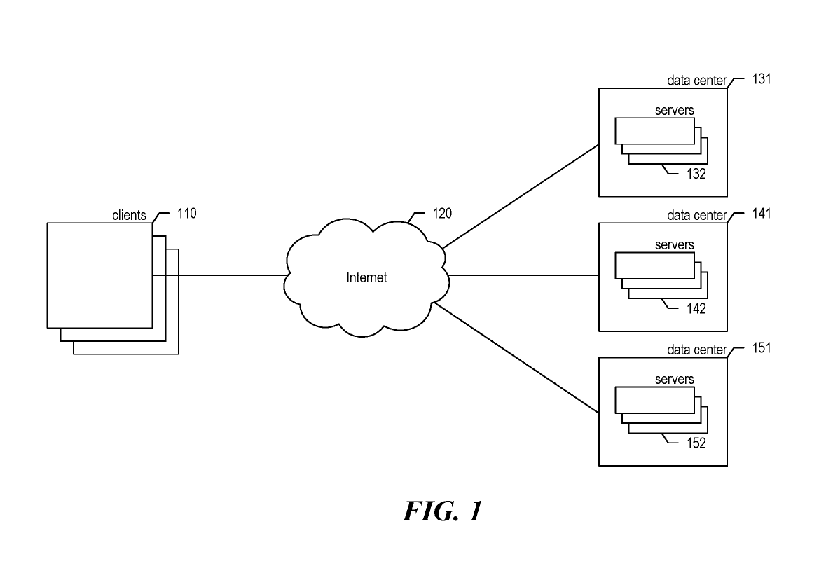

FIG. 1 is a network diagram showing the environment in which the facility operates in some examples. The network diagram shows clients 110 each typically being used by different user. Each of the clients execute software enabling its user to interact with documents, such as a browser enabling its user to interact with web page documents. The clients are connected by the Internet 120 and/or one or more other networks to data centers such as data centers 131, 141, and 151, which in some examples are distributed geographically to provide disaster and outage survivability, both in terms of data integrity and in terms of continuous availability. Distributing the data center geographically also helps to minimize communications latency with clients in various geographic locations. Each of the data centers contain servers, such as servers 132, 142, and 152. Each server can perform one or more of the following: serving content and/or bibliographic information for documents; and storing information about relationships between named entities.

While various examples of the facility are described in terms of the environment outlined above, those skilled in the art will appreciate that the facility may be implemented in a variety of other environments including a single, monolithic computer system, as well as various other combinations of computer systems or similar devices connected in various ways. In various examples, a variety of computing systems or other different devices are used as clients, including desktop computer systems, laptop computer systems, automobile computer systems, tablet computer systems, smart phones, personal digital assistants, televisions, cameras, etc.

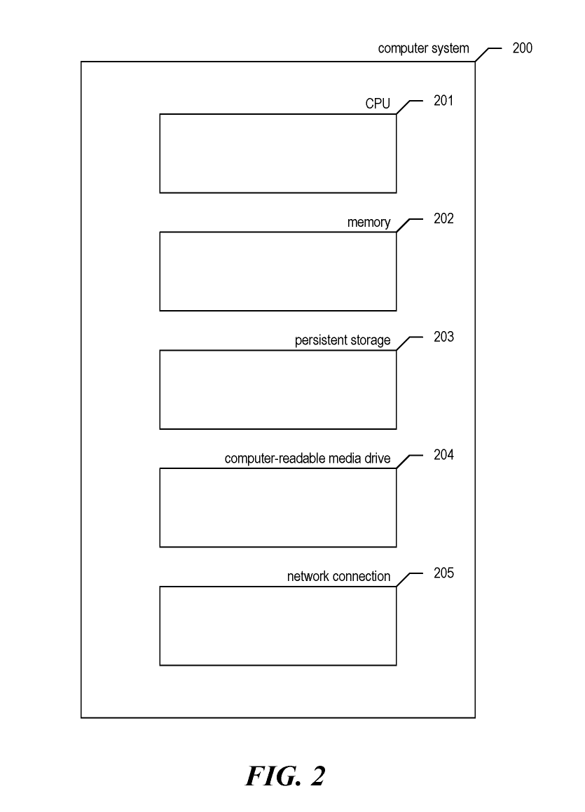

FIG. 2 is a block diagram showing some of the components typically incorporated in at least some of the computer systems and other devices on which the facility operates. In various examples, these computer systems and other devices 200 can include server computer systems, desktop computer systems, laptop computer systems, netbooks, mobile phones, personal digital assistants, televisions, cameras, automobile computers, electronic media players, etc. In various examples, the computer systems and devices include zero or more of each of the following: a central processing unit (“CPU”) 201 for executing computer programs; a computer memory 202 for storing programs and data while they are being used, including the facility and associated data, an operating system including a kernel, and device drivers; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet or another network and its networking hardware, such as switches, rootrs, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

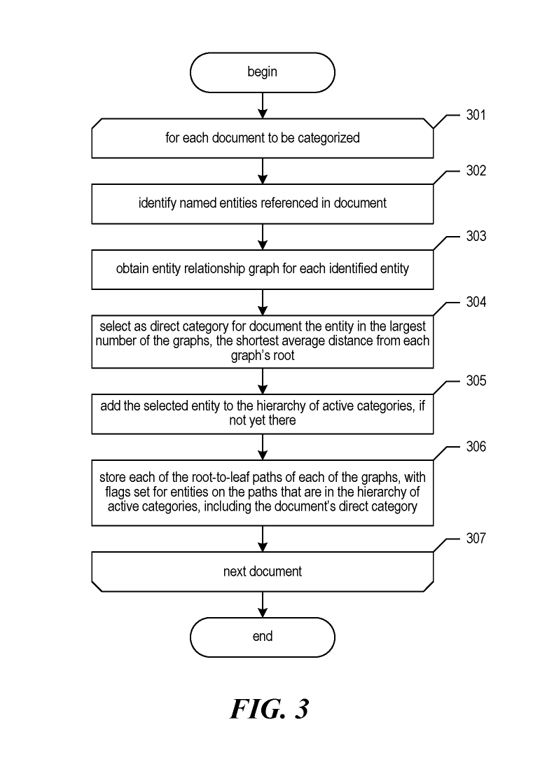

FIG. 3 is a flow diagram showing a process performed by the facility to determine direct categories in some examples. At 301-307, the facility loops through each document to be categorized. In various examples, these documents comprise document sets corresponding to, for example, documents added to a bookmark list, a reading list, or a history list. At 302, the facility identifies named entities that are referenced in the current document, such as by comparing the content of the current document to a list of named entities and various alternative forms of expression of each. At 303, the facility obtains an entity relationship graph for each named entity identified at 302.

In some examples, this involves retrieving an existing entity relationship graph for an identified entity. In some examples, this involves constructing an entity relationship graph for an identified entity. For example, in some examples, the facility uses a service such as MICROSOFT SATORI from MICROSOFT CORPORATION to return child entities of a queried entity, as follows: (1) the facility establishes the identified entity as the root of the entity relationship graph; (2) the facility queries for child entities of the identified entity, and adds then to the entity relationship graph as children of the root; and (3) for each of the children added to the entity relationship graph, the facility recursively queries for their children and adds them to the entity relationship graph until no more descendants of the root remain to be added to the entity relationship graph.

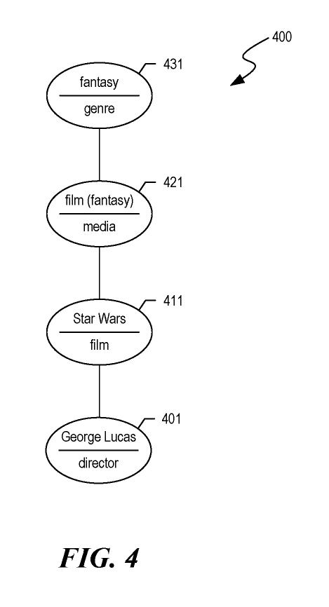

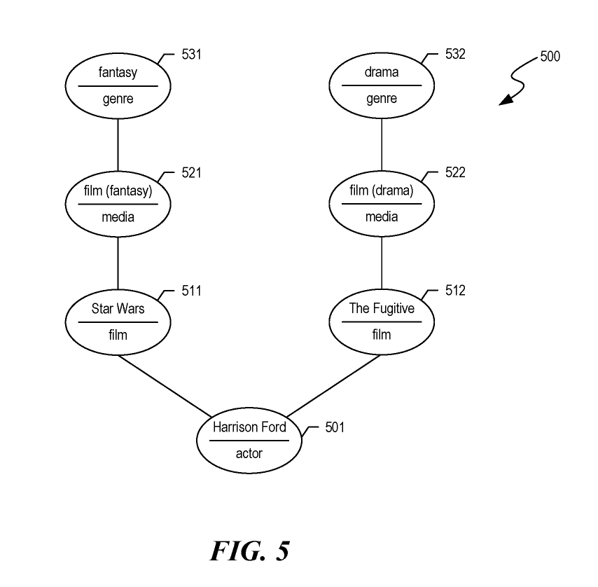

FIGS. 4-5 show sample entity relationship graphs obtained by the facility for the named entities “George Lucas” and “Harrison Ford,” which are both referenced by a first document in an example document set that has the document identifier 11111111.

FIG. 4 is a graph diagram showing a sample entity relationship graph for the named entity “George Lucas” retrieved or constructed by the facility in some examples. In entity relationship graph 400, root node 401 indicates that “George Lucas” is a director entity. Child node 411 from root node 401 indicates that “Star Wars” is a film entity. Child node 421 of node 411 indicates that “Film (Fantasy)” is a media entity and child node 431 from node 421 indicates that “Fantasy” is genre entity. Because node 431 has no children, it is a leaf node.

FIG. 5 is a graph diagram showing a sample entity relationship graph for the named entity “Harrison Ford” retrieved or constructed by the facility in some examples. In entity relationship graph 500, root node 501 indicates that “Harrison Ford” is an actor entity. Root node 501 has two child entities: entity 511 that indicates that “Star Wars” is a film, and entity 512 that indicates that “The Fugitive” is a film. In a manner that mirrors “Star Wars” node 411, shown in FIG. 4, Star Wars node 511, shown in FIG. 5, has a “Film (Fantasy)” child node 521, which in turn has a “Fantasy” child node 531. “The Fugitive” node 512 has a “Film (Drama)” child node 522, which in turn has a “Drama” child node 532, which is a leaf node.

Returning to FIG. 3, at 304, the facility selects as the direct category for the current document the entity that is in the largest number of the graphs obtained at 303, the shortest average distance from each graph's root. Considering the document having document identifier 11111111, for which the facility obtained the two entity relationship graphs shown in FIGS. 4 and 5, the following entities are common to both graphs: “Star Wars,” “Film (Fantasy),” and “Fantasy.” Of these three entities, the one having the shortest average distance from each graph's root is “Star Wars,” which has an average distance from the root of 1, as compared to “Film (Fantasy)” which has an average distance of 2 and “Fantasy” which has an average distance of 3. Accordingly, the facility selects “Star Wars” as the direct category for the document having document identifier 11111111.

At 305, the facility adds the entity selected at 304 to a hierarchy of active categories, if this entity is not already in the hierarchy. In the example, the direct category for the document having document identifier 11111111 is added at a time when the hierarchy of active categories is empty. Accordingly, after the addition of “Star Wars” to the hierarchy, the hierarchy is in the state shown below in Table 1.

TABLE 1
Star Wars

At 306, the facility stores each of the root-to-leaf paths of each of the graphs obtained at 303, with flags set for entities on the paths that are in the hierarchy of active categories, including the document's direct category selected at 304. The three paths stored at 306 for the document having document identifier 11111111 are shown below in Table 2.

TABLE 2
“George Lucas” → “Star Wars” → “Film (Fantasy)” → “Fantasy”
“Harrison Ford” → “Star Wars” → “Film (Fantasy)” → “Fantasy”
“Harrison Ford” → “The Fugitive” → “Film (Drama)” → “Drama”

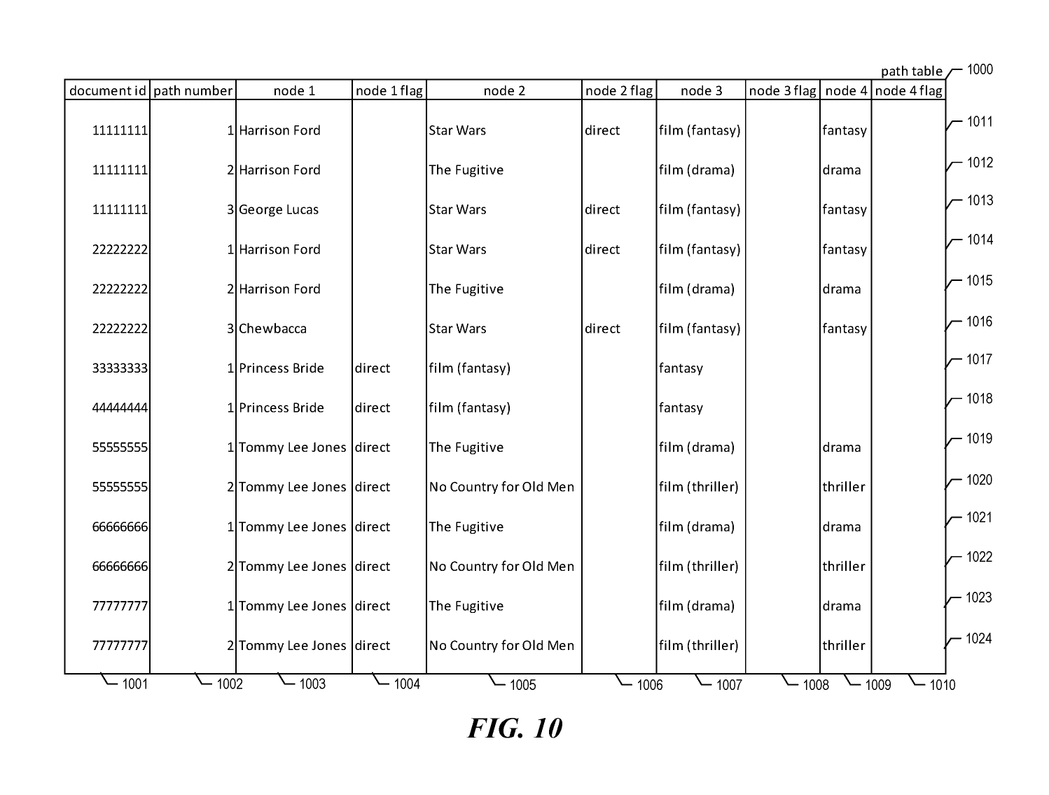

In the first and second paths, the facility flags the “Star Wars” entity as a direct category. In some examples, the facility stores the paths in a path table, such as the path table shown in FIG. 10 and discussed below. At 307, if additional documents remain to be categorized, the facility continues at 301 to categorize the next document of the set, else this process concludes.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

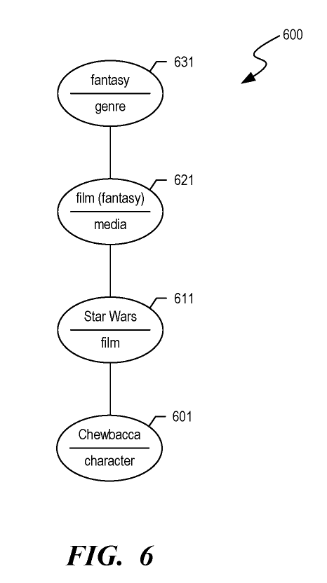

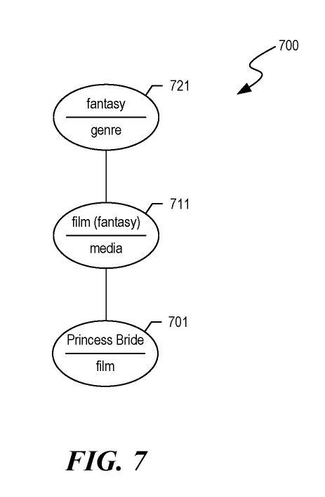

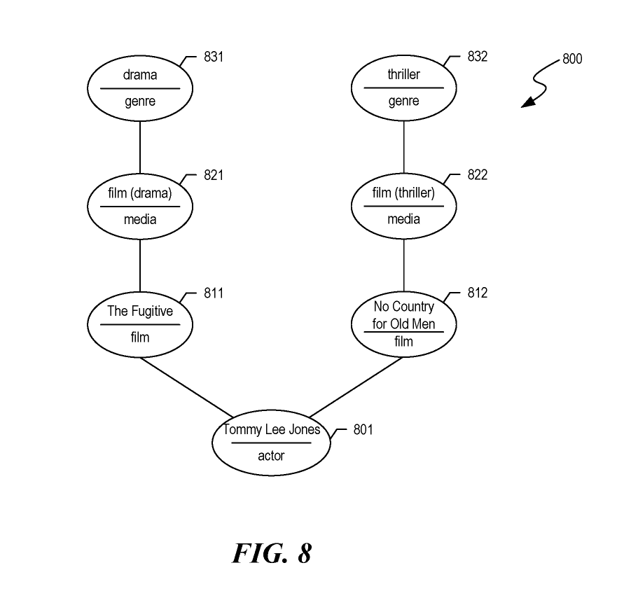

FIGS. 6-8 are graph diagrams showing additional graphs obtained and processed by the facility in order to select direct categories for six additional documents in the example. FIG. 6 contains a graph 600 for the named entity “Chewbacca;” FIG. 7 contains a graph 700 for the named entity “Princess Bride;” and FIG. 8 contains a graph 800 for the named entity “Tommy Lee Jones.” In the example, a document having document identifier 22222222 references the named entities “Harrison Ford” and “Chewbacca”, and thus graphs 500 and 600 are obtained for this document, and used to select as its direct category “Star Wars.” Two documents having document identifier 33333333 and 44444444 each reference only the named entity “Princess Bride;” accordingly the facility obtains for each of these two document graph 700, and uses it as a basis to select as the direct category of both documents the entity “Princess Bride.” Finally, each of the documents having document identifiers 55555555, 66666666, and 77777777 references only the named entity “Tommy Lee Jones;” accordingly, the facility obtains for each of these three documents graph 800, and uses it as a basis for selecting the entity “Tommy Lee Jones” as the direct category for each of these three documents. In some examples, the facility records these selected direct categories in a document category table for the documents.

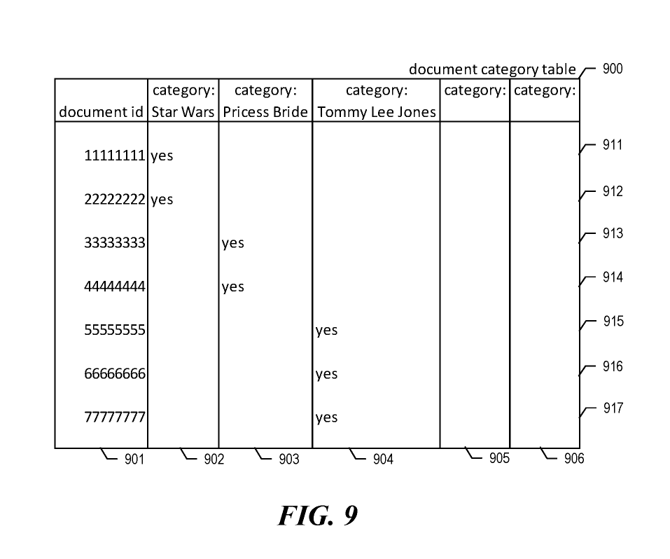

FIG. 9 is a data structure diagram showing sample contents of a document category table used by the facility in some examples to store categories attributed to documents for use by a particular user. The document category table 900 is made up of rows, such as rows 911-917 each corresponding to a different document. Each row is divided into the following columns: a document identifier column 901 containing an identifier identifying the document to which the row corresponds; a category:“Star Wars” column 902 that indicates whether a “Star Wars” category has been attributed to the document; a category:Princess Bride column 903 that indicates whether a “Princess Bride” category has been attributed to the document; a category:“Tommy Lee Jones” column 904 that indicates whether a “Tommy Lee Jones” category has been attributed to the document; and presently-unused category columns 905 and 906. For example, row 912 indicates that only the “Star Wars” category has been attributed to the document having document identifier 22222222.

While FIG. 9 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; may contain a much larger number of rows than shown, etc.

Based upon the selection of direct categories for the documents in the example, the current hierarchy of active categories is shown below in Table 3.

TABLE 3
Princess Bride
Star Wars

FIG. 10 is a data structure diagram showing sample contents of a path table used by the facility in some examples to store all of the root-to-leaf paths among the entity relationship graphs obtained for each document in the document set. The path table 1000 is made up of rows such as rows 1011-1024 each corresponding to a different path recorded for a particular document. Each row is divided into the following columns: a document identifier column 1001 that contains identifier identifying the document to which the row corresponds; a path number column 1002 that contains a path number identifying the particular path to which the row corresponds; a node 1 column 1003 that identifies the entity at the beginning of the path, which is the root node of the corresponding entity relationship graph; a node 1 flag column 1004 that contains an indication of whether entity identified in the node 1 column has been selected as a category for the document to which the row corresponds; a node 2 column 1005, node 3 column 1007, and node 4 column 1009, which each contain an indication of the entity in the next position in the path to which the row correspond; and a node 2 flag column 1006, node 3 flag column 1008, and node 4 flag column 1010 which each indicate whether the entity in the corresponding node column has been selected as a category for the document to which the row corresponds. For example, row 1013 of the path table indicates that the document having document ID 11111111 has the path shown in the second row of Table 2 above, and further indicates that the “film (fantasy)” entity in this path has been selected as category for this document. In some examples, the path table contains as many node and node flag columns as necessary to represent the longest path encountered among the entity relationship graphs processed by the facility.

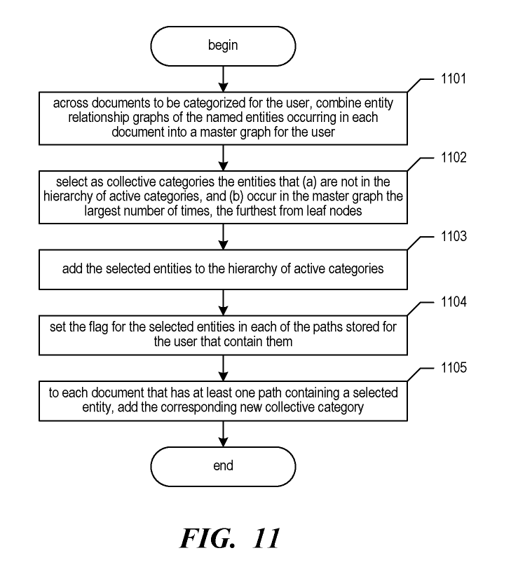

FIG. 11 is a flow diagram showing a first process performed by the facility in some examples to identify collective categories for a set of documents. At 901, across the set of documents to be categorized for the user, the facility combines entity relationship graphs of the named entities occurring in each document into a master graph for the user.

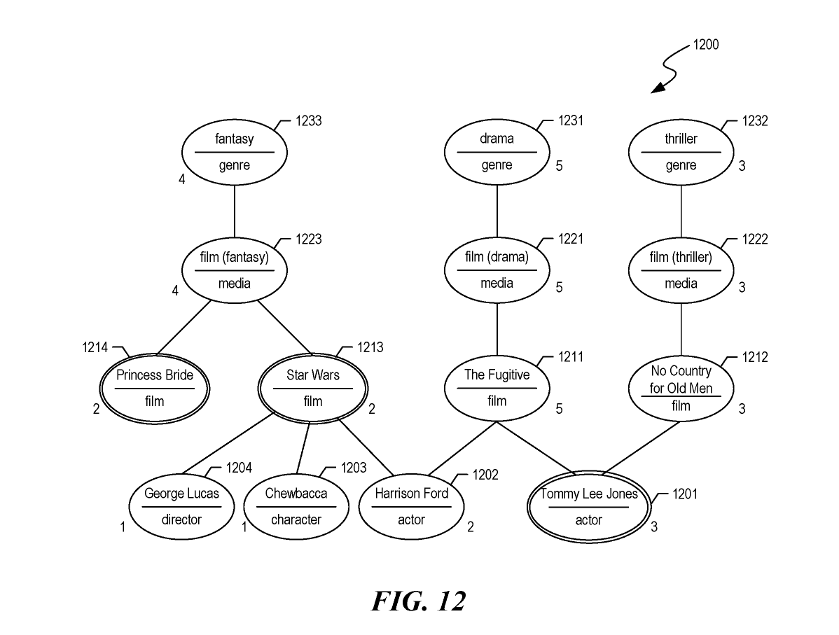

FIG. 12 is a graph diagram showing a sample master graph constructed by the facility based upon the example discussed above in connection with FIGS. 4-8. The master graph 1200 is a combination of the entity relationship graphs obtained for the facility for the documents having document identifiers 11111111, 22222222, 33333333, 44444444, 55555555, 66666666, and 77777777. Each entity in the master graph has a weight indicating the number of times the entity occurs in the same position in the entity relationship graphs that are combined. For example, the weight for entity 1223 indicates that this entity is included four times among the entity relationship graphs for the seven sample documents. In the master graph, entities that have been selected as direct categories for one or more documents are identified by a double oval: entities 1201, 1213 and 1214. In the master graph, entities 1201, 1202, 1203, 1204, and 1214 are roots, and entities 1231, 1232, 1233 are leaves.

Returning to FIG. 11, at 1102, the facility selects as collective categories the entities that both are not in the hierarchy of active categories, and occur in the master graph the largest number of times, the furthest from leaf nodes. In the sample master graph shown in FIG. 12, the entities having the highest weights are entities 1211, 1221, and 1231 each having a weight of 5 and being on a first path, and entities 1223 and 1233, each having a weight of 4 and being on a second path. Among entities 1211, 1221, and 1231, entity 1211 is the furthest from leaf node 1231, and so is selected as a collective category. Similarly, among entities 1223 and 1233, entity 1223 is the furthest from leaf node 1233 and thus is also selected as a collective category.

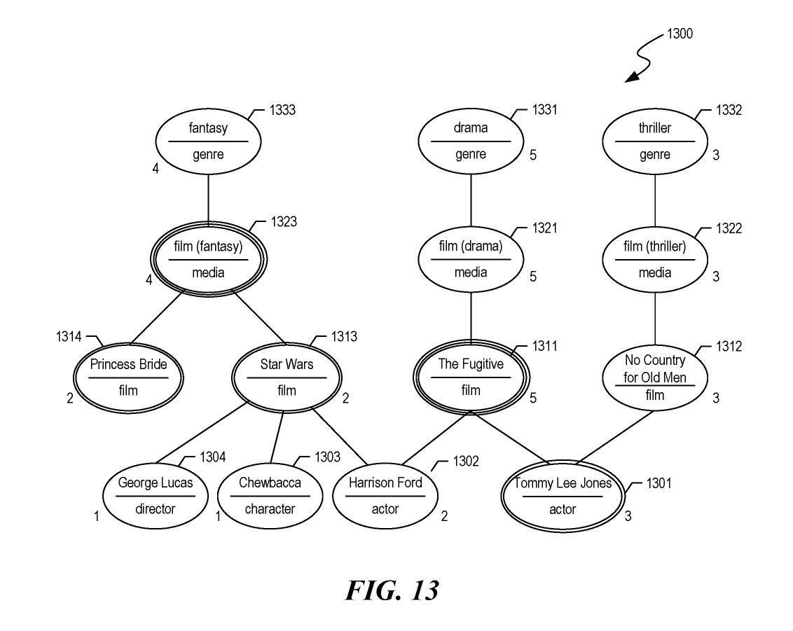

FIG. 13 is a graph diagram showing sample contents of a master graph updated to reflect the selection of collective categories. It can be seen that, in the updated master graph 1300, triple ovals have been added to entities 1311 and 1323, signifying that these two entities have been selected as collective categories.

Returning to FIG. 11, at 1103, the facility adds the entities selected as collective categories at 1102 to the hierarchy of active categories. Table 4 below shows the addition of the “film (fantasy)” and “The Fugitive” collective categories to the hierarchy of active categories.

TABLE 4

```
film (fantasy)
  Princess Bride
  Star Wars
The Fugitive
  Tommy Lee Jones
```

At 1104, the facility sets the flag for the entities selected as collective categories at 1102 in each of the paths stored for the user that contain these entities.

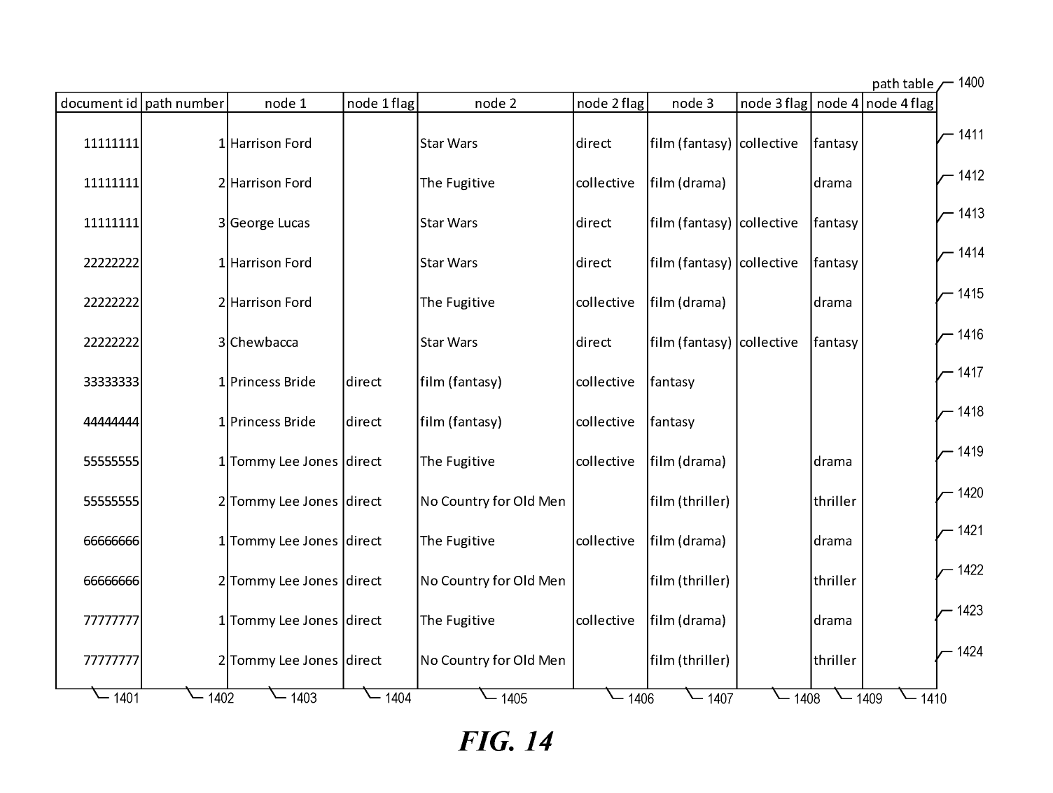

FIG. 14 is a data structure diagram showing sample contents of the path table updated to reflect the selection of collective categories. By comparing path table 1400 shown in FIG. 14 to path table 1000 shown in FIG. 10, it can be seen that the facility has added the following indications of collective categories: in rows 1411 and 1413, indications that the “film (fantasy)” entity is a collective category for the document having document identifier 11111111; in rows 1414 and 1416, an indication that the “film (fantasy)” entity is a collective category for the document having document identifier 22222222; in rows 1417 and 1418, an indication that the “film (fantasy)” entity is a collective category for the documents having document identifiers 33333333 and 44444444; and, in rows 1419, 1421, and 1423, indications that the “The Fugitive” entity is a collective category for the documents having document identifier 55555555, 66666666, and 77777777.

Returning to FIG. 11, at 1105, the facility adds to each document that has at least 1 path containing an entity selected at 1102 the corresponding new collective category. After 1105, this process concludes.

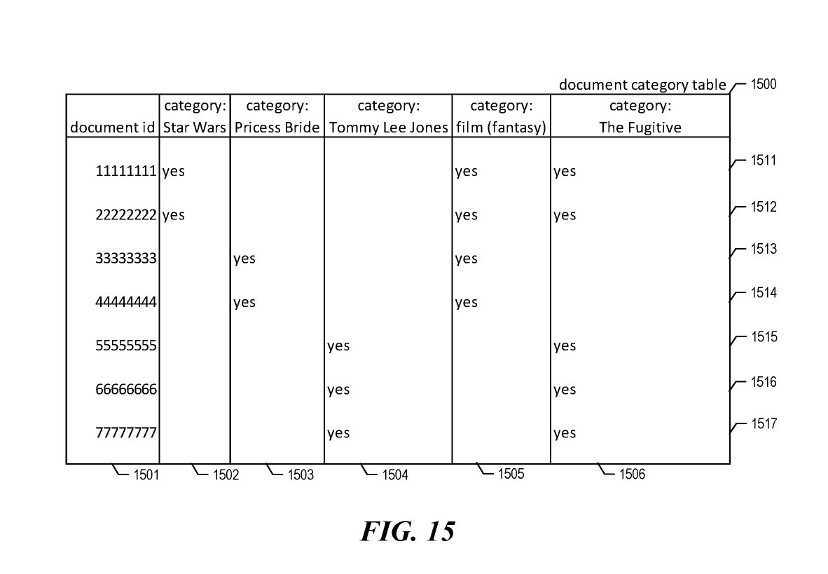

FIG. 15 is a data structure diagram showing sample contents of the document category table updated to reflect the addition of collective categories. By comparing document category table 1500 in FIG. 15 to document category table 900 shown in FIG. 9, it can be seen that the new collective category “film (fantasy)” has been added as a category to the documents having document IDs 11111111, 22222222, 33333333, and 44444444; and that the category “The Fugitive” has been added as a category to the documents having document identifiers 11111111, 22222222, 55555555, 66666666, and 77777777.

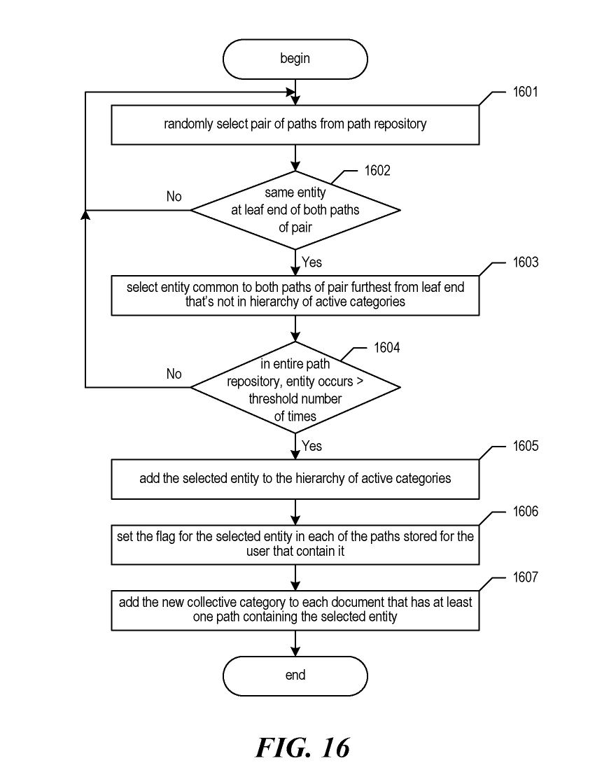

FIG. 16 is a flow diagram showing a second process performed by the facility in some examples to select a new collective category for a set of documents. At 1601, the facility randomly selects a pair of paths from the path repository, such as the path table. At 1602, if the same entity is a leaf in both paths are randomly selected at 1601, then the facility continues at 1603, else the facility continues at 1601 to randomly select a new pair of paths. At 1603, the facility selects the entity common to both paths of the pair furthest from the leaf end of these paths that is not in the hierarchy of active categories. At 1604, if, in the entire path repository, the entity selected at 1603 occurs more than a threshold number of times, then the facility continues at 1605, else the facility continues at 1601 to randomly select a new pair of paths. At 1605, the facility adds the entity selected at 1603 to the hierarchy of active categories. At 1606, the facility sets the flag for the selected entity in each of the paths stored for the user that contain it, such as in the path table. At 1607, the facility adds the new collective category to each document that has at least one path containing the selected entity, such as in the document category table. After 1607, this process concludes.

In terms of the example, the facility first randomly selects the pair of paths shown in rows 1015 and 1016 of the path table shown in FIG. 10. At 1602, however, the facility determines that this pair of paths has different entities (“drama” and “fantasy”) at their leaf ends, so it returns to 1601.

The facility next randomly selects the pair of paths shown in rows 1012 and 1021 of the path table shown in FIG. 10. This pair of paths does have the same entity (“drama”) at the leaf end of both paths. Common to this pair of paths are the entities “The Fugitive,” “film (drama)” and “drama.” Of these, the furthest from the leaf end is “The Fugitive.” The facility assesses the entire path table, and finds 5 occurrences the “The Fugitive” entity, in rows 1012, 1015, 1019, 1021, and 1023. Because these 5 occurrences exceed a sample threshold of 3 occurrences, the facility adds the “The Fugitive” entity as a collective category. When the process shown in FIG. 16 is later repeated, the facility makes a similar assessment to add the “film (fantasy)” entity as a collective category based on randomly selected pair paths shown in rows 1016 and 1017 of the path table shown in FIG. 10.

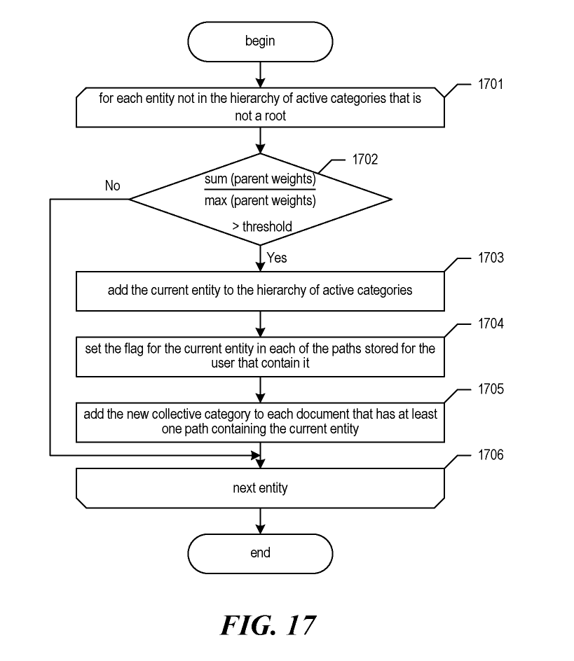

FIG. 17 is a flow diagram showing a third process performed by the facility in some examples to select new collective categories for a set of documents. At 1701-1706, the facility loops through each entity among the entity relationship graphs obtained for the named entities referenced by the documents of the set of documents that is not already in the hierarchy of active categories and is not a root node. In some examples, the facility maintains a parent weight table in which all the entities occurring among the obtained entity relationship graphs is listed, together with the number of times each entity has each of its unique parents.

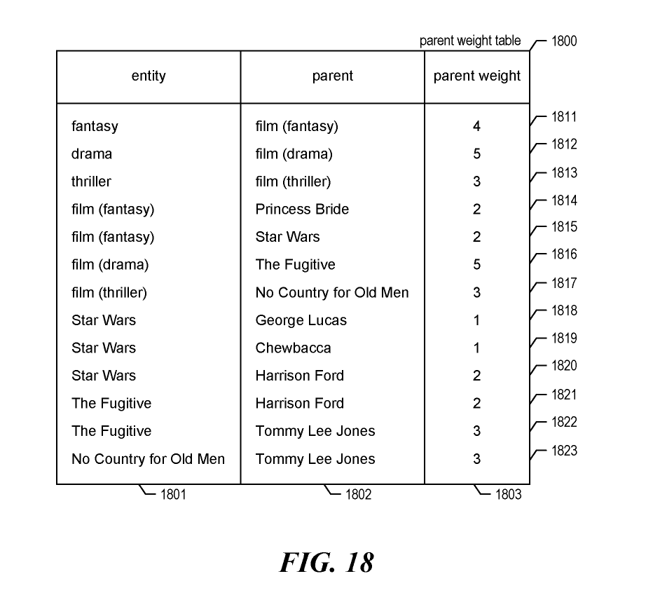

FIG. 18 is a data structure diagram showing sample contents of a parent weight table used by the facility in some examples to store the pattern of connection between entities among the entity relationship graphs obtained for named entities occurring in documents or set of documents. Table 1800 is made up of rows, such as row 1811-1823, each corresponding to a different combination of an entity and one of its unique parent entities. Each of the rows is divided into the following columns: an entity column 1801 identifying an entity to which the row corresponds; a parent column 1802 identifying the unique parent of that entity to which the row corresponds; and a parent column 1803 indicating the number of times the parent to which the row corresponds occurs as the parent of the entity to which the row corresponds. For example, rows 1818-1820 indicate that, among the graphs for the documents, the “Star Wars” entity has a “George Lucas” parent once, a “Chewbacca” parent once, and a “Harrison Ford” parent twice. This corresponds to the weights 1, 1, and 2 shown for entities 1204, 1203, and 1202 in the master graph shown in the FIG. 12.

Returning to FIG. 17, at 1702, if the ratio of the sum of the entity's parents' weights to the largest among the entity's parents' weights exceeds a threshold, then the facility continues at 1703, else the facility continues at 1706. At 1703, the facility adds the current entity to the hierarchy of active categories. At 1704, the facility sets the flag for the current entity in each of the paths stored for the user that contain this entity. At 1705, the facility adds the new collective category to each document that has at least one path containing the current entity. At 1706, if additional entities not in the hierarchy of active categories remain to be processed, then the facility continues at 1701 to process the next such entity, else this process concludes.

In terms of the example: entities 1201, 1213, and 1214 shown in FIG. 12 are already in the hierarchy of active categories, and so are not considered; entities 1202, 1203, and 1204 have no parents (i.e., are roots), and are also not considered, (and are not present in the parent weight table). Among the remaining entities, the ratio computed by the facility at 1702 is as follows: for “fantasy,” 1; for “drama,” 1; for “thriller,” 1; for “film (fantasy),” 2; for “film (drama),” 1; for “film (thriller),” 1; for “The Fugitive,” 1.7; and for “No Country for Old Men,” 1. Using the sample threshold of 1.5, the facility selects the entities “film (fantasy)” (2) and “The Fugitive” (1.7).

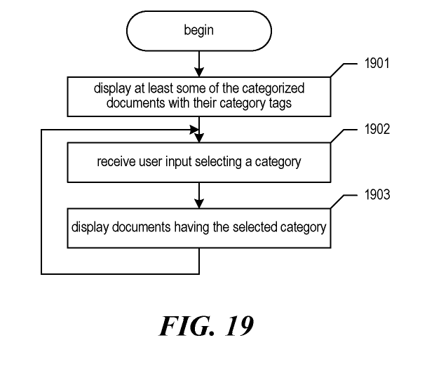

FIG. 19 is a flow diagram showing a process perform by the facility in some examples to make categories attributed to documents available to the user. At 1901, the facility displays at least some of the categorized documents with their category tags. At 1902, the facility receives user input selecting a category; at 1903, the facility displays the documents having the category selected at 1902. After 1903, the facility continues at 1902 to receive user input selecting another category.

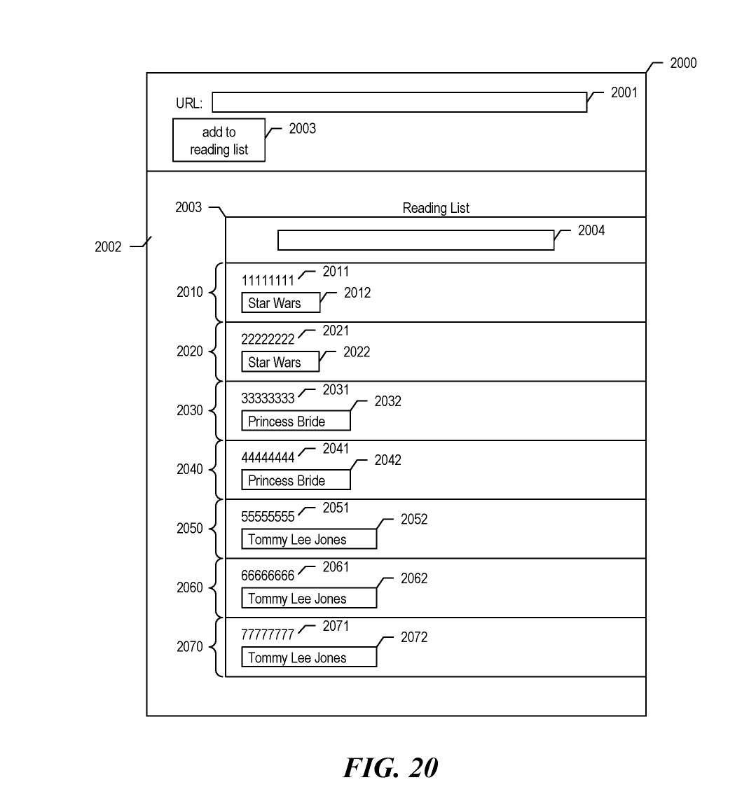

FIGS. 20-23 show visual user interfaces presented by the facility in some examples. FIG. 20 is a display diagram showing an entire reading list user interface presented by the facility in some examples. The user interface includes browser window 2000, which contains a URL field 2001 into which a user can enter the URL of a webpage; a client area 2002 in which a web page can be displayed; and an add to reading list control 2003 that the user can activate while a web page or other document is displayed in order to add that web page or document to a reading list. The browser also displays a reading list 2003 that contains entries 2010, 2020, 2030, 2040, 2050, 2060, and 2070, each corresponding to a different document that has been added to a reading list. Each entry contains information identifying a document, as well as one or more category tags. For example, entry 2040 is for the document having document identifier 44444444 2041, and includes a category tag 2042 for the “Princess Bride” category. As shown in FIG. 20, the entries reflect only direct categories for each document, and have not yet been populated with collective categories for any document.

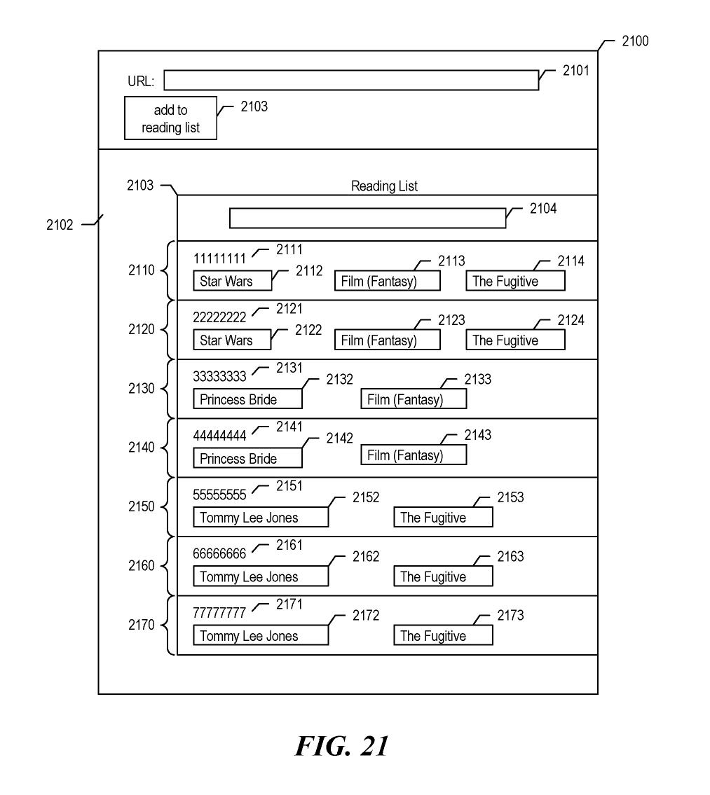

FIG. 21 is a display diagram showing the entire reading list user interface after it has been updated to include collective categories. For example, it can be seen that the “film (fantasy)” category 2143 has been added to entry 2140 for the document having document identifier 44444444. At this point, the user can pursue different interactions to display only the documents having a particular category tag. For example, the user can click on “film (fantasy)” category tag 2143 in order to display just the documents having this category. Alternatively, the user can type the string “film (fantasy)”—or just “fantasy”—into a search field 2104 in order to display the same documents.

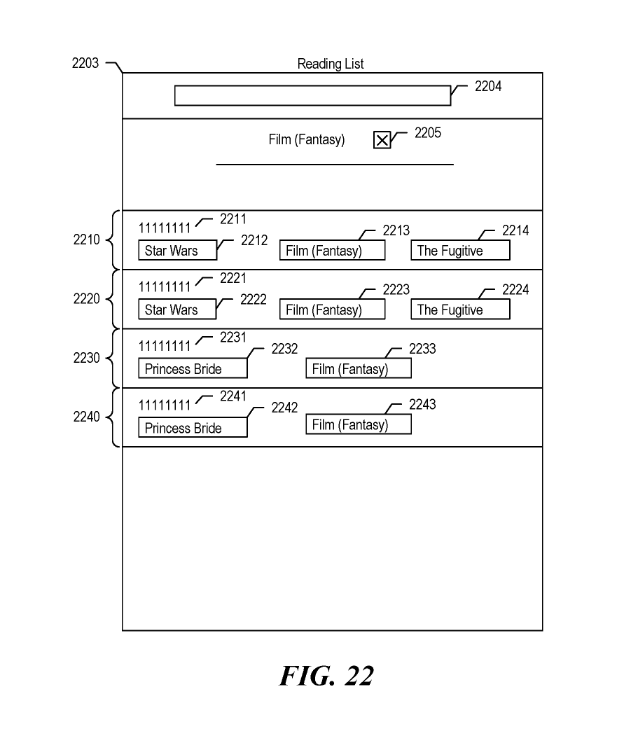

FIG. 22 is a display diagram showing the reading list user interface updated to display the documents in a single category. It can be seen that the reading list 2203 contains only entries 2210, 2220, 2230, and 2240, omitting entries 2150, 2160, and 2170 shown in FIG. 21. Accordingly, only the documents in the category “film (fantasy)” are shown. In order to revert to the entire reading list, the user can activate control 2205 to dismiss the “film (fantasy)” category.

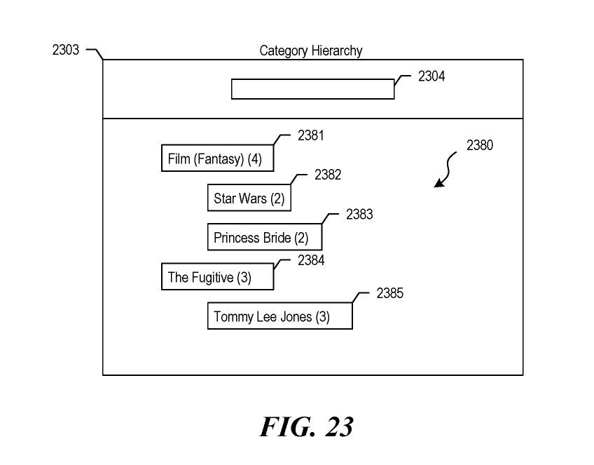

FIG. 23 is a display diagram showing a category hierarchy user interface presented by the facility in some examples. In a category hierarchy window 2303, the facility displays a hierarchy 2380 of active categories. In the hierarchy, a “film (fantasy)” category includes the “Star Wars” category 2382 and the “Princess Bride” category 2383. Also, a “The Fugitive” category 2384 contains the “Tommy Lee Jones” category 2385. In each category, a count of documents within the category is displayed in parentheses. The user can click on any of the five category tags in order to generate a filtered reading list as shown in FIG. 22.

While the sample user interfaces shown in FIGS. 20-23 relate to a reading list, those skilled in the art will appreciate that these can be similarly implemented with regard to sets of web pages or other documents collected in any number of ways.

In some examples, the facility provides a method in a computing system for attributing subject categories to documents in a set of documents collected on behalf of the user, the method comprising: for each document in the set of documents, identifying one or more named entities referenced by the document; for each of the identified named entities, obtaining an entity relationship graph representing relationships between the identified named entity and named entities directly or indirectly related to the identified named entity; selecting an entity occurring in at least some of the entity relationship graphs obtained for named entities referenced by the document; attributing the selected entity to the document as a direct category; adding the obtained entity relationship graphs to a collection of entity relationship graphs; choosing an entity occurring in at least some of the entity relationship graphs in the collection of entity relationship graphs; and attributing the chosen entity to the documents whose entity relationship graphs contain the chosen entity as a collective category.

In some examples, the facility provides a computing system for attributing subject categories to documents in a set of documents collected on behalf of the user, comprising: a processor; and a memory having contents whose execution by the processor: for each document in the set of documents, identifies one or more named entities referenced by the document; for each of the identified named entities, obtains an entity relationship graph representing relationships between the identified named entity and named entities directly or indirectly related to the identified named entity; selects an entity occurring in at least some of the entity relationship graphs obtained for named entities referenced by the document; attributes the selected entity to the document as a direct category; adds the obtained entity relationship graphs to a collection of entity relationship graphs; chooses an entity occurring in at least some of the entity relationship graphs in the collection of entity relationship graphs; and attributes the chosen entity to the documents whose entity relationship graphs contain the chosen entity as a collective category.

In some examples, the facility provides a memory having contents configured to cause a computing system to perform a method for attributing subject categories to documents in a set of documents collected on behalf of the user, the method comprising: for each document in the set of documents, identifying one or more named entities referenced by the document; for each of the identified named entities, obtaining an entity relationship graph representing relationships between the identified named entity and named entities directly or indirectly related to the identified named entity; selecting an entity occurring in at least some of the entity relationship graphs obtained for named entities referenced by the document; attributing the selected entity to the document as a direct category; adding the obtained entity relationship graphs to a collection of entity relationship graphs; choosing an entity occurring in at least some of the entity relationship graphs in the collection of entity relationship graphs; and attributing the chosen entity to the documents whose entity relationship graphs contain the chosen entity as a collective category.

In some examples, the facility provides a method in a computing system for attributing subject categories to documents in a set of documents collected on behalf of the user, the method comprising: for each document in the set of documents, based on semantic analysis of the document, identifying one or more direct subjects for the document; attributing to the document the direct subjects identified for the document; based on semantic analysis across the documents of the set, identifying one or more collective subjects each for a proper subset of the set of documents; and attributing each identified collective subject to each document of the subset of the set of documents for which it was identified.

In some examples, the facility provides a computing system for attributing subject categories to documents in a set of documents collected on behalf of the user, comprising: a processor; and a memory having contents whose execution by the processor: for each document in the set of documents, based on semantic analysis of the document, identifies one or more direct subjects for the document; attributes to the document the direct subjects identified for the document; based on semantic analysis across the documents of the set, identifies one or more collective subjects each for a proper subset of the set of documents; and attributes each identified collective subject to each document of the subset of the set of documents for which it was identified.

In some examples, the facility provides a memory having contents configured to cause a computing system to perform a method for attributing subject categories to documents in a set of documents collected on behalf of the user, the method comprising: for each document in the set of documents, based on semantic analysis of the document, identifying one or more direct subjects for the document; attributing to the document the direct subjects identified for the document; based on semantic analysis across the documents of the set, identifying one or more collective subjects each for a proper subset of the set of documents; and attributing each identified collective subject to each document of the subset of the set of documents for which it was identified.

It will be appreciated by those skilled in the art that the above-described facility may be straightforwardly adapted or extended in various ways. While the foregoing description makes reference to particular examples, the scope of the invention is defined solely by the claims that follow and the elements recited therein.

We claim:

1. A method in a computing system for attributing subject categories to documents in a set of documents collected on behalf of the user, the method comprising:
for each document in the set of documents,
identifying one or more named entities referenced by the document;
for each of the identified named entities, obtaining an entity relationship graph representing relationships between the identified named entity and named entities directly or indirectly related to the identified named entity;
selecting an entity occurring in at least some of the entity relationship graphs obtained for named entities referenced by the document;
attributing the selected entity to the document as a direct category;
adding the obtained entity relationship graphs to a collection of entity relationship graphs;
choosing an entity occurring in at least some of the entity relationship graphs in the collection of entity relationship graphs;
attributing the chosen entity to the documents whose entity relationship graphs contain the chosen entity as a collective category;
receiving user input selecting a category attributed to a proper set of the set of documents; and
based at least in part on the receiving, causing to be displayed information identifying at least a portion of the documents in the proper set of documents.

2. The method of claim 1, further comprising for each of at least a portion of the set of documents, causing to be displayed information identifying the document together with, for each direct or collective category attributed to the document, a visual indication of the category.

3. The method of claim 1 wherein obtaining each entity relationship graph comprises constructing the entity relationship graph based upon individual relationships each between a pair of named entities.

4. The method of claim 1 wherein at least some of the documents in the set of documents are web pages.

5. The method of claim 1, further comprising adding a document to the set of documents collected on behalf of the user by adding the document to a reading list, adding the document to a bookmark list, or adding the document to a history list.

6. The method of claim 1, further comprising:
compiling the collection of entity relationship graphs into a single master entity relationship graph; and
analyzing the master entity relationship graph as a basis for choosing the chosen entity.

7. The method of claim 1 wherein each of the obtained entity relationship graphs has a root corresponding to the named entity referenced in a document in the set of documents and one or more leaves, the method further comprising:
assembling a collection of the root-to-leaf paths present in each of the entity relationship graphs in the collection;
analyzing the collection of root-to-leaf paths as a basis for choosing the chosen entity.

8. The method of claim 1 wherein each of the obtained entity relationship graphs has a root corresponding to the named entity referenced in a document in the set of documents and one or more leaves, the method further comprising:
assembling a collection of the root-to-leaf paths present in each of the entity relationship graphs in the collection;
until an entity is chosen:
randomly selecting a pair of root-to-leaf paths in the collection of root-to-leaf paths;
if the pair of root-to-leaf paths has the same leaf entity:
if there a distinguished entity that (a) occurs in both root-to-leaf paths, (b) is furthest from the leaves of the paths, and (c) is not already among entities attributed to any document in the set of documents:
determining how many root-to-leaf paths in the collection that contain the distinguished entity;
if the determined number of root-to-leaf paths exceeds a threshold, choosing the distinguished entity.

9. The method of claim 1, further comprising:
compiling the collection of entity relationship graphs into a single master entity relationship graph in which each entity has a weight indicating the number of root-to-leaf paths in which the entity occurs with the same entity-to-leaf path;
compiling from the master entity relationship graph connectivity statistics reflecting, for each entity in the master graph, the number of entity-to-leaf paths in which it occurs with each unique parent; and
analyzing the master entity relationship graph as a basis for choosing the chosen entity.

10. The method of claim 1 wherein the received user input selects a displayed visual indication of the selected category.

11. The method of claim 1 wherein the received user input submits a query matching the selected category.

12. A computing system for attributing subject categories to documents in a set of documents collected on behalf of the user, comprising:
a processor; and
a memory having contents whose execution by the processor:
for each document in the set of documents,
based on semantic analysis of the document, identifies one or more direct subjects for the document;
attributes to the document the direct subjects identified for the document;
based on semantic analysis across the documents of the set, identifies one or more collective subjects each for a proper subset of the set of documents;
attributes each identified collective subject to each document of the subset of the set of documents for which it was identified; and
causes to be displayed information identifying a document in the set of documents together with, for each direct or collective category attributed to the document, a visual indication of the category.

13. The computing system of claim 12 wherein the memory has contents whose execution by the processor further:
for each document in the set of documents,
identifies one or more named entities referenced by the document; and
for each of the identified named entities, obtains an entity relationship graph for the identified named entity representing relationships between the identified named entity and named entities directly or indirectly related to the identified named entity,
and wherein the obtained entity relationship graphs are used in both the semantic analysis of each document and the semantic analysis across the documents of the set.

14. A memory having contents configured to cause a computing system to perform a method for attributing subject categories to documents in a set of documents collected on behalf of the user, the method comprising:
for each document in the set of documents,
based on semantic analysis of the document, identifying one or more direct subjects for the document;
attributing to the document the direct subjects identified for the document;
based on semantic analysis across the documents of the set, identifying one or more collective subjects each for a proper subset of the set of documents;
attributing each identified collective subject to each document of the subset of the set of documents for which it was identified; and
causing to be displayed information identifying a document in the set of documents together with, for each direct or collective category attributed to the document, a visual indication of the category.

15. The memory of claim 14, the method further comprising:
for each document in the set of documents,
identifying one or more named entities referenced by the document; and
for each of the identified named entities, obtaining an entity relationship graph for the identified named entity representing relationships between the identified named entity and named entities directly or indirectly related to the identified named entity,
and wherein the obtained entity relationship graphs are used in both the semantic analysis of each document and the semantic analysis across the documents of the set.

16. The memory of claim 15, the method further comprising:
compiling the collection of entity relationship graphs into a single master entity relationship graph; and
analyzing the master entity relationship graph as a basis for choosing the chosen entity.

17. The memory of claim 15 wherein each of the obtained entity relationship graphs has a root corresponding to the named entity referenced in a document in the set of documents and one or more leaves, the method further comprising:
assembling a collection of the root-to-leaf paths present in each of the entity relationship graphs in the collection;
analyzing the collection of root-to-leaf paths as a basis for choosing the chosen entity.

18. The memory of claim 15, the method further comprising:
compiling the collection of entity relationship graphs into a single master entity relationship graph in which each entity has a weight indicating the number of root-to-leaf paths in which the entity occurs with the same entity-to-leaf path;
compiling from the master entity relationship graph connectivity statistics reflecting, for each entity in the master graph, the number of entity-to-leaf paths in which it occurs with each unique parent; and
analyzing the master entity relationship graph as a basis for choosing the chosen entity.

19. The memory of claim 14, the method further comprising:
receiving user input selecting a category attributed to a proper set of the set of documents, the user input selecting a displayed visual indication of the selected category; and
based at least in part on the receiving, causing to be displayed information identifying at least a portion of the documents in the proper set of documents.

20. The memory of claim 14, the method further comprising:
receiving user input selecting a category attributed to a proper set of the set of documents, the user input submitting a query matching the selected category; and
based at least in part on the receiving, causing to be displayed information identifying at least a portion of the documents in the proper set of documents.
